(19) United States
(12) Patent Application Publication
(10) Pub. No.: US 2008/0162327 A1
(43) Pub. Date: Jul. 3, 2008

(54) Methods and systems for supplier quality management

(76) Inventors: Mark D. Cujak, Berlin, WI (US); Edward Kralik, Woodstock, GA (US); Trina R. McCormick, Appleton, WI (US); Dixon Ng, Alpharetta, GA (US); James E. Schoenholz, Bangkok (TH); Leona M. Hammel, Georgetown, TX (US); Donald E. Dalton, Woodstock, GA (US); Thomas F. Dungan, Neenah, WI (US); Johnny D. Mercer, Kennesaw, GA (US)

Correspondence Address: DORITY & MANNING, P.A., POST OFFICE BOX 1449, GREENVILLE, SC, 29602-1449, US

(21) Appl. No.: 11/648,183

(22) Filed: Dec. 29, 2006

(51) Int. Cl. G06Q 40/00

(52) U.S. Cl. 705/37

(57) ABSTRACT

An automated supplier quality management system includes tools to support standardized supplier quality assessments and storage and searching of supplier profiles. Supplier information can be filtered and sorted to provide qualification of suppliers, such as contract manufacturers or other suppliers. In some embodiments, supplier quality management can include the use of tools that automatically generate forms for use in auditing outside or internal suppliers. For instance, audit definition parameters may be provided and one or more audit worksheets may be prepared based on the parameters. For instance, a spreadsheet may include various auditing requirements and make requirements applicable to an audit visible based on the parameters while hiding other inapplicable requirements.

### BACKGROUND

Modern manufacturing enterprises typically require coordination of numerous outside suppliers. For example, large-scale manufacturing of consumer products entails ensuring appropriate support for all aspects of the manufacturing process for each product, including raw materials, manufacturing capability, and packaging capability. Depending on the product and/or manufacturer involved, each aspect may involve numerous sources and numerous suppliers.

The enterprise may be subject to an array of standards, guidelines, and regulations with regard to each product line it provides. For example, health care products must meet stringent quality and safety guidelines. Other product lines must meet different quality and safety guidelines that are just as stringent. The enterprise itself may also have internal quality standards for the manufacturing process and/or the end product. Additionally, some products may be subject to still further guidelines, such as third-party certifications. Any of the above requirements may introduce still further complications to the enterprise in the form of documentation requirements regarding compliance with any of the above standards.

Therefore, when the enterprise turns to outside sources for all or part of a manufacturing process or to meet other needs, the enterprise needs to ensure that the outside sources are capable of meeting various standards and guidelines and that each outside source's compliance with such standards and guidelines is adequately documented. In some situations, this may be an ongoing task. Accordingly, the enterprise may have audit procedures whereby the enterprise can determine whether a particular outside source complies with applicable standards and guidelines. The audits themselves may come in many varieties depending on such factors as the type of outside source, previous audits of the source (if any), and the particular activities for which the source will be used.

Large enterprises may comprise numerous sub-entities responsible for different manufacturing activities and products. Such sub-entities may have useful information about outside suppliers that may be pertinent to other sub-entities in determining which outside suppliers are meeting various standards and guidelines, and which suppliers are not. For example, in an enterprise comprising multiple business units, a first business unit may have data, such as audit data, regarding an outside source that may be under consideration for use by a second business unit. Depending upon the second business unit's needs with regard to the outside source, the first business unit's audit data may be useful to the second business unit.

Enterprise-scale software presently exists to address some of the logistical needs of large business entities. For example, document management systems may provide computer-based tracking and management of personnel, procedural, and other enterprise support documents. For instance, the QSI Software Suite (available from IBS America of Lexington, Mass.) provides functionality including version and document control.

However, systems and methods of user-friendly and enterprise-wide management of suppliers remain desirable.

### SUMMARY

Objects and advantages of the present invention will be apparent to one of skill in the art upon careful review of the disclosure. Such objects and advantages include providing systems and methods for an enterprise to leverage already-available internal knowledge regarding the quality status of various outside suppliers, as well as systems and methods for determining and ensuring compliance by such suppliers with pertinent quality (and other) standards.

Computer-based methods and systems can provide solutions for the enterprise in determining which suppliers are qualified to provide support to the enterprise. The qualification determinations may be based on knowledge already known to the enterprise. Furthermore, embodiments of the present subject matter may enable the enterprise to make new determinations of qualification and perform ongoing activities with regard to supplier qualification, such as determining audit scope and detail requirements.

A method of supplier management can include receiving an supplier identification query. The query may include data defining one or more supplier capability requirements. For example, the capability requirement(s) may specify the task or tasks to be performed by the supplier. For example, the task may identify such information as the type of manufacturing process, materials, final product, services, and/or other needs that are to be met by the supplier.

The method may further comprise identifying one or more supplier quality requirements. The supplier quality requirements may be identified by the system based on the supplier capability requirements. For example, certain quality requirements may be associated with certain tasks. Alternatively or additionally, quality requirements may be included as part of the query. Supplier quality requirements may include regulatory, safety, and certification needs that the supplier must satisfy to be acceptable to the enterprise for a particular project. For example, an enterprise may require that certain suppliers be ISO-certified for certain tasks. The enterprise may require additional compliance for other tasks—for example, a contract manufacturer for medical products may be required to be ISO-certified and meet regulatory standards, such as FDA requirements.

The method may further comprise accessing a plurality of supplier profiles to determine which suppliers are capable—i.e., which suppliers are known to be able to meet the capability requirements. Supplier profiles may be stored in one or more databases and may include information such as supplier address information and points of contact, supplier classification information, performance evaluations, quality audit history information, and links to other information related to the supplier.

Once capable suppliers have been identified, the method further comprises determining which capable suppliers are approved suppliers. Supplier approval can be determined based on accessing quality assessment data included in the supplier profiles or otherwise associated with the supplier profiles. The quality assessment data can be used to determine if any capable suppliers meet the quality requirements.

For example, the quality assessment data may comprise data provided by one or more assessment teams that have evaluated the supplier, such as in one or more audits of the supplier. For example, as noted above, the quality requirements for a task may include that the supplier is ISO-certified. The quality assessment data may be evaluated to determine if the enterprise has one or more records establishing that the supplier has been ISO-certified and the details of such certification.

The quality assessment data may be evaluated in any suitable manner. For example, the quality assessment data may include one or more scored areas, with each area compared to a threshold score to determine if the supplier is qualified for that area. The threshold scores for each area may correlate to the quality requirements for the particular task and/or provided as part of the supplier identification query.

Once capable and approved suppliers have been determined, the method can further include generating an approved supplier list including those suppliers who are both capable and approved. Determining which suppliers are approved may include accessing one or more quality assessment scores as noted above.

In some embodiments, a method of supplier quality management can address actions needed to qualify a supplier. For example, as noted above, a supplier identification query may be received and one or more capable suppliers identified. However, the capable supplier(s) may not be associated with previous qualification data, or existing qualification data may be inadequate to make a qualification determination, out of date, or otherwise insufficient. Depending upon the type of supplier and other requirements, more recent or more thorough assessment data may be needed. For example, a supplier may have been previously qualified as a contract manufacturer for a first process. However, in order for the supplier to be qualified as a contract manufacturer for a second process, more thorough assessment data may be needed. The method may include steps to generate or complete one or more assessments needed to qualify the supplier.

An audit schedule may be generated based on parameters characterizing the supplier and the needed task. For example, schedule considerations may include product, regulatory, and business risks, the supplier's performance history, the supplier's audit history, and task-specific risks. The audit schedule may be provided to one or more users for confirmation and/or adjustment. Generating an audit schedule may also include accessing records identifying one or more individuals for inclusion in an audit team.

The method may include generating one or more audit documents for use by the audit team. For example, worksheets, report templates, and other forms may be generated based on the supplier type, audit type, and audit scope. The one or more audit documents may be used by the audit team to perform a quality assessment of the supplier. Quality assessment data from the audit may then be associated with supplier for use in future qualifications.

In some embodiments, the method may comprise further actions based on the audit results. For example, the quality assessment data may indicate one or more areas where the supplier is deemed inadequate. These areas may be identified, for example, by scoring various sections of the audit and comparing each section to a baseline value. The baseline value may change depending on the supplier type, particular task, and other criteria. One or more corrective actions may be suggested based on the identified inadequate area(s).

A quality management system can include at least one computing device configured to access stored instructions and one or more databases including a plurality of supplier profile records and a plurality of supplier quality assessment records. For example, the stored instructions may comprise one or more processes, applications, modules, or components that configure the computing device (or a combination of devices) to perform actions including receiving a supplier query, the query including data defining one or more supplier capability requirements. The instructions can further configure the computing device to determine one or more supplier quality requirements, access the database(s); and determine which suppliers, if any, meet both the supplier capability requirements and the supplier quality requirements. Any such suppliers may be included in an approved supplier list generated by the computer.

A method of assessing supplier quality can include receiving data including one or more parameters defining the nature of a supplier quality assessment and generating at least one assessment form, the form customized to the defined supplier quality assessment. For example the parameter(s) may include data defining the type of entity to be audited, the type of assessment or audit to be performed, and the standard or scope of the assessment. For instance, the method may include generating one or more drop-down selection menus providing selectable options to a user to select the parameter(s).

Generating at least one assessment form can include selecting at least some predefined criteria, and/or assessment requirements from a set of assessment requirements based on the one or more parameters defining the assessment. The selected requirements may then be assembled into one or more audit worksheets. In some embodiments, the audit worksheet(s) are included in a spreadsheet, and the form is generated by one or more scripting elements such as macros included in the spreadsheet. In some embodiments, the spreadsheet includes the entire set of assessment requirements and the selected assessment requirements are made visible. In other embodiments, the audit worksheets are assembled into a separate document.

The present disclosure discusses various audits of outside suppliers. However, any of the teachings herein may be applied in quality assessments, audits, and other activities regarding internal suppliers—i.e. components within an enterprise.

The discussion of particular file types and implementations is meant for purposes of example only and is not intended to be limiting.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the appended figures, in which:

FIG. 1 is a block diagram illustrating an exemplary business environment wherein an enterprise interacts with outside suppliers;

FIG. 2 is a block diagram of components in an exemplary computer-based quality management system;

FIG. 3 is a flowchart illustrating exemplary steps in a process of determining an approved supplier for a task;

FIG. 4 is a flowchart illustrating exemplary steps in a process of determining whether a supplier is qualified;

FIG. 5 is a diagram showing data structures in an exemplary supplier profile; and

FIGS. 6A through 6F illustrate components in exemplary customizable supplier auditing document, and, in this example, each of FIG. 6A through 6F comprises a different tab in a spreadsheet.

Use of like reference numerals in different features is intended to illustrate like or analogous components

### DETAILED DESCRIPTION

This disclosure now makes reference in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents

The technology discussed herein makes reference to servers, databases, software applications, and other computer-based systems, as well as actions taken and information sent to and from such systems. One of ordinary skill in the art will recognize the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel. When data is obtained or accessed between a first and second computer system or component thereof, the actual data may travel between the systems directly or indirectly. For example, if a first computer accesses a file or data from a second computer, the access may involve one or more intermediary computers, proxies, and the like. The actual file or data may move between the computers, or one computer may provide a pointer or metafile that the second computer uses to access the actual data from a computer other than the first computer, for instance.

The present disclosure also makes reference to the relay of communicated data over a network such as the Internet. It should be appreciated that such network communications may also occur over alternative networks such as a dial-in network, a local area network (LAN), wide area network (WAN), public switched telephone network (PSTN), the Internet, intranet or Ethernet type networks and others over any combination of hard-wired or wireless communication links.

The various computer systems discussed herein are not limited to any particular hardware architecture or configuration. Any suitable programming, scripting, or other type of language or combinations of languages may be used to implement the teachings contained herein. Embodiments of the methods and systems set forth herein may be implemented by one or more general-purpose or customized computing devices accessing software instructions rendered in a computer-readable form. Embodiments of the methods and systems set forth herein may also be implemented by hard-wired logic or other circuitry, including, but not limited to application-specific circuits. Of course, combinations of computer-executed software and hard-wired logic may be suitable, as well.

Embodiments of the methods disclosed herein may be executed by one or more suitable computing devices. Such devices may access one or more computer-readable media that embody computer-readable instructions which, when executed by at least one computer, cause the at least one computer to implement one or more embodiments of the methods disclosed herein.

Components of the presently-disclosed technology, such as databases, may be implemented using one or more computer-readable media. Any suitable computer-readable medium or media may be used to implement or practice the present subject matter, including diskettes, drives, and other magnetic-based storage media, optical storage media, including disks (including CD-ROMS, DVD-ROMS, and variants thereof), flash, RAM, ROM, and other memory devices, and the like

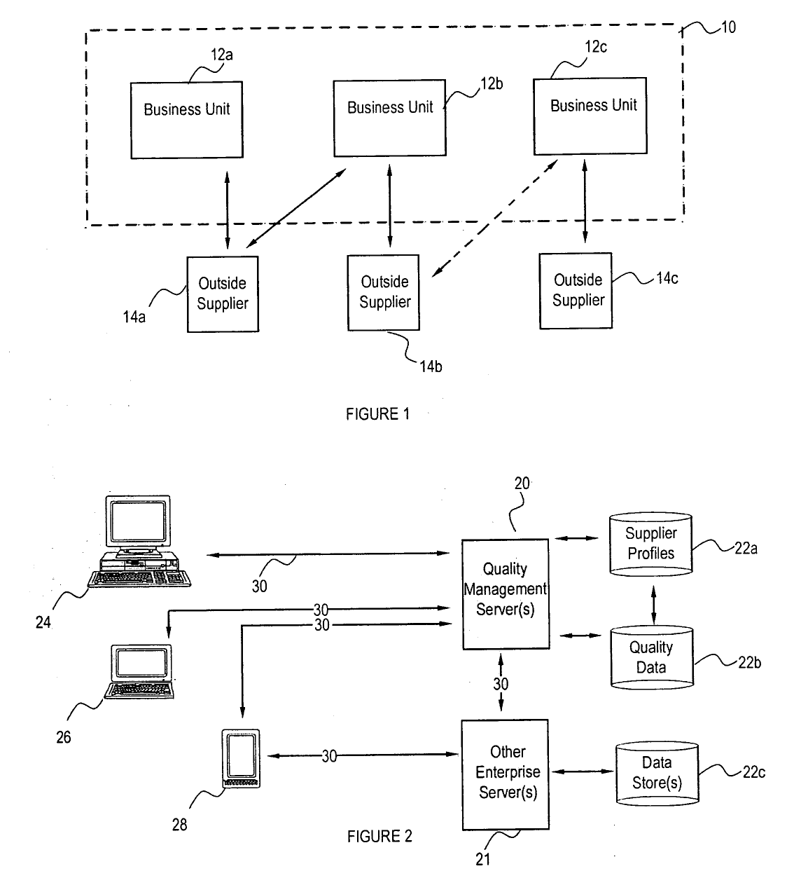

FIG. 1 is a block diagram of an enterprise 10 comprising three exemplary business units 12a, 12b, and 12c. Enterprise 10 interacts with outside suppliers 14a, 14b, and 14c through its business units. For instance, business units 12a and 12b both interact with outside supplier 14a. Business unit 12b further interacts with outside supplier 14b. Business unit 12c is shown in this example as interacting with outside supplier 14c and, as indicated by the dashed line, is pursuing the possibility of interacting with outside supplier 14b. Of course, an enterprise may comprise more or fewer business units and/or may interact with more (in some instances, hundreds or thousands) or fewer outside suppliers.

For purposes of the present subject matter, a business unit comprises any suitable component of enterprise 10. For example, a manufacturing company's business units may comprise several different divisions producing respective product lines and/or product lines for differing geographical regions or markets. Outside suppliers may comprise any number or type of entities relied upon by enterprise 10 to meet one or more tasks or requirements. For example, an outside supplier can include, but is not limited to: a contract manufacturer, a raw materials supplier, an intermediate materials supplier, a packaging contractor, a parts supplier, or any type of service supplier, including professional services, manufacturing support services, customer support services, personnel support services, and the like.

When interacting with an outside supplier, each business unit evaluates the outside supplier's capabilities. For instance, if outside supplier 14a is a contract manufacturer, business unit 12a has likely evaluated supplier 14a's abilities to complete contract manufacturing tasks, including production capabilities, costs, logistical matters, and the like. Furthermore, business unit 12 has likely evaluated supplier 14a's compliance with various quality requirements. For example, enterprise 10 may impose quality requirements for use of an outside supplier, such as ISO or other certification. Furthermore, depending on the type of tasks performed by an outside supplier, federal, state, and other regulations and guidelines may be applicable. Before interacting with and relying upon outside supplier 14a, business unit 12a likely has conducted one or more audits to qualify outside supplier 14a. Furthermore, business unit 12a may have conducted such audits on other outside suppliers who were not selected for various reasons. Similarly, business units 12b and 12c may have conducted audits for other outside suppliers.

However, enterprise 10 as a whole may not be fully aware of the extent of data available regarding outside suppliers. For instance, in FIG. 1, business unit 12c is interacting with outside supplier 14c and considering outside supplier 14b. For instance, outside supplier 14b may be another contract manufacturer that business unit 12c is considering to supplement or replace outside supplier 14c. In order to utilize outside supplier 14b, business unit 12c must ensure that outside supplier 14b is capable of meeting business unit 12c's needs and that supplier 14b will not violate any applicable laws, regulations, or quality requirements.

In order to do so, business unit 12c may plan an audit of outside supplier 14b. However, business unit 12b may have data that may be usable by business unit 12c in the audit. For instance, if business unit 12b is using outside supplier 14b for the same or similar purposes that business 12c is considering, no audit may even be necessary, or the scope of the audit may be greatly reduced. However, business unit 12b's information may not be available to business unit 12c.

In some cases, business unit 12c may be further at a disadvantage. For instance, business unit 12c may be entirely unaware of business unit 12a's activities. For instance, business units 12a and 12c may be widely geographically dispersed units of a multinational corporation. Conceivably, business unit 12a may have already performed an extensive analysis of outside supplier 14a which may be directly applicable to business unit 12c's needs. For example, if business units 12a and 12c both develop medical devices, any contract manufacturers employed by such units must meet strict safety and health guidelines. Ensuring compliance with such guidelines can be a complex and expensive task. Business unit 12c may be at a competitive disadvantage if business unit 12c is unaware that outside supplier 14a has been fully qualified, since, absent such knowledge business unit 12c may needlessly perform an expensive qualification audit of outside supplier 14c.

Accordingly, the enterprise may employ an enterprise-wide quality management system whereby different business units can share and access supplier quality information. In some embodiments, the capabilities of existing enterprise-wide management software may be leveraged by adding supplier quality data to existing record structures. Furthermore, existence of a supplier quality database allows portions of the quality assessment process to be wholly or partially automated. In some embodiments, the quality management system may also be used to qualify, audit, and otherwise manage activities of internal units, as well. For instance, if business unit 12c wishes to employ business unit 12b as a supplier, some or all aspects of the quality management system may be applied to internal business unit 12b as if it were an outside supplier.

FIG. 2 is a block diagram showing components in an exemplary embodiment of a quality management system. In this example, computing devices 24, 26, and 28 are linked via network connections 30 to one or more quality management system servers 20 which have access to supplier profile store 22a and quality data store 22b. Supplier profile store 22a and quality data store 22b may be combined into a single database or may comprise multiple linked databases in some embodiments. Network connections 30 may comprise any suitable type of data transmission paths through any medium, including wired and wireless local area networks, wide-area networks such as the Internet, and other computer network types such as virtual private networks.

FIG. 2 further illustrates other enterprise server(s) 21 with access to additional data store(s) 22c. For instance, other enterprise server(s) 21 may include one or more enterprise-level systems such as SAP (and/or other enterprise resource planning (ERP) systems) and associated data. Other enterprise servers 21 are shown as linked to quality management server(s) 20 and computing device 28 by network connections 30. However, computing devices such as 24, 26, and other computing devices associated with the enterprise may be linked to other enterprise server(s) 21, either via network connections 30 or another network. Similarly, quality management server(s) 20 and other enterprise server(s) 21 may be linked to one another by the same network or a different, separate connection. As will be discussed in further detail below, by linking the quality management server(s) 20 to other enterprise-level systems, existing data regarding outside suppliers can be leveraged on an enterprise-wide level.

Quality management system servers 20 comprise any type and number of computing devices running one or more applications, processes, or other components to provide enterprise-wide quality management functionality. In some embodiments, quality management system servers 20 may comprise one or more computing devices used in support of other enterprise-wide software. In such embodiments, supplier quality management functionality may be provided as a component to one or more other systems.

For instance, in one embodiment, the quality management system is implemented alongside an enterprise-wide document and supplier management system such as QSI, available from IBS America of Lexington, Mass. For example, supplier quality profiles may be linked to location records in QSI corresponding to each supplier. Audit records, procedures, and rules used in determining the extent of and results of quality assessments may be stored as additional components or modules of the document/supplier management software.

In any event, the quality management servers 20 have access to supplier profiles 22a that characterize various suppliers and quality data 22b. Quality data store 22b may include substantive data indicating the results of supplier quality audits, lists of additional information that is needed from suppliers for ongoing quality audits, and supplier information such as capacities, contact information, input requirements. Quality data store 22b may further include data related to the auditing process. For instance, different types of suppliers and/or tasks may require different levels of information and different frequencies of evaluation. Quality data store 22b may include a database or other record(s) that include rules that define the type and extent of quality reviews. Furthermore, quality data store 22b may include audit metadata for one or more past audits of suppliers, including personnel who performed the audit and related contact information, timeframes for the audit, extent of the audit, and so on. In some embodiments, quality data store 22b may include one or more audit documents. For example, as discussed below, one or more spreadsheets (or other documents) may be used to generate customized audit worksheets for specific types of audits. The base spreadsheets (i.e. pre-customized spreadsheets) and completed audit worksheets may be included in the data stored by quality data store 22b.

In some embodiments, some or all of the documents included in quality data store 22b are maintained as controlled documents in a validated system. For instance, supplier profiles, audit spreadsheets, and completed audit documents are maintained as controlled documents.

Exemplary processes that may be performed by a supplier quality management system based on supplier profiles, quality data, and other information will now be discussed.

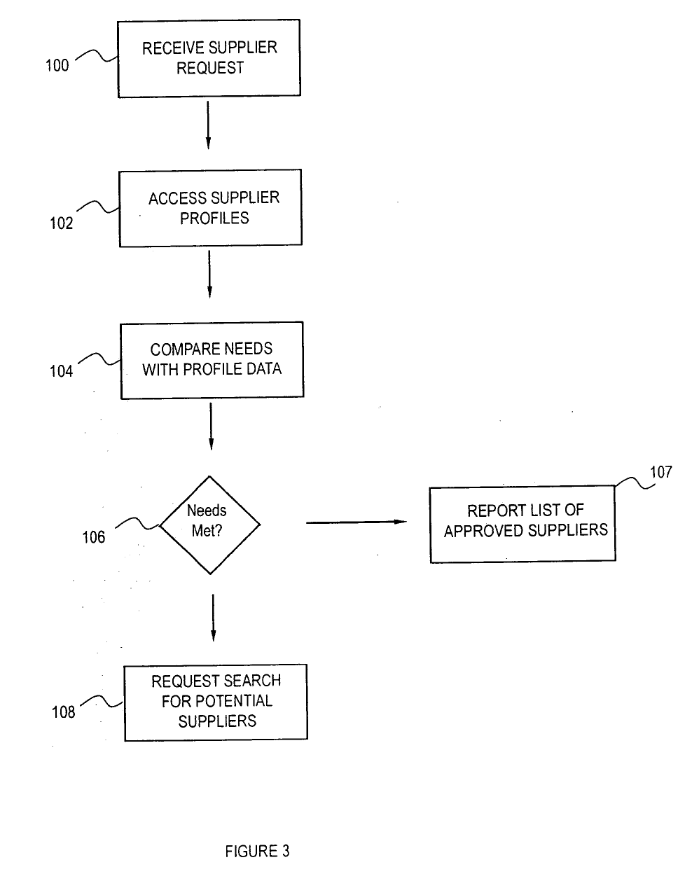

FIG. 3 illustrates steps in an exemplary process for determining if a supplier is already known to an enterprise as being an approved supplier. At step 100, a supplier request is received by quality management server 20. For instance, the supplier request may set forth one or more tasks that are to be performed by the outside supplier. Using the example from FIG. 1, business unit 12c may submit a request indicating that a contract manufacturing provider is required. The request may include additional information, such as the type of task (i.e. manufacturing, supply, service, maintenance, packaging, etc.), quantities of materials (or other items) involved, and other requirements, such as logistical requirements including delivery time and location. Information in the supplier request may in a structured format such as a markup language (XML) document, an SQL request, or any suitable format that can be processed by the server.

At step 102, the quality management server accesses data regarding each supplier as stored in a supplier profile. For instance, some suppliers may already be indicated as approved for certain tasks, with approval data indicated in the supplier profiles. In some embodiments, quality data store 22b may maintain a list of approved suppliers searchable by supplier/task type, and the list of approved suppliers may be checked first before other profiles are scanned. However, if no such pre-approved supplier list is maintained, or if no pre-approved suppliers match the requirements for the task at hand, the supplier profiles may be queried.

As an example, in FIG. 1, outside suppliers 14a and 14b were approved to meet the respective needs of business units 12a and 12b. Personnel associated with business units 12a and 12b may have provided approval information to the system using computing devices such as 24, 26, and 28 indicating the requirements that each of suppliers 14a and 14b are able to meet. As will be discussed below, suppliers may be added to the approved supplier list by the quality management system as well.

In any event, at step 104, the needs set forth in the supplier request are analyzed and compared to data for each supplier. For example, as noted above, the supplier profile database may be queried for profiles that match the requirements for the task(s) set forth in the supplier request. At step 106, if a given supplier can meet the needs of the supplier request, the supplier is included in a list of approved suppliers for the task at step 107. If no suppliers in the approved meet the needs set forth in the request, then at step 108 a search for potential suppliers is generated.

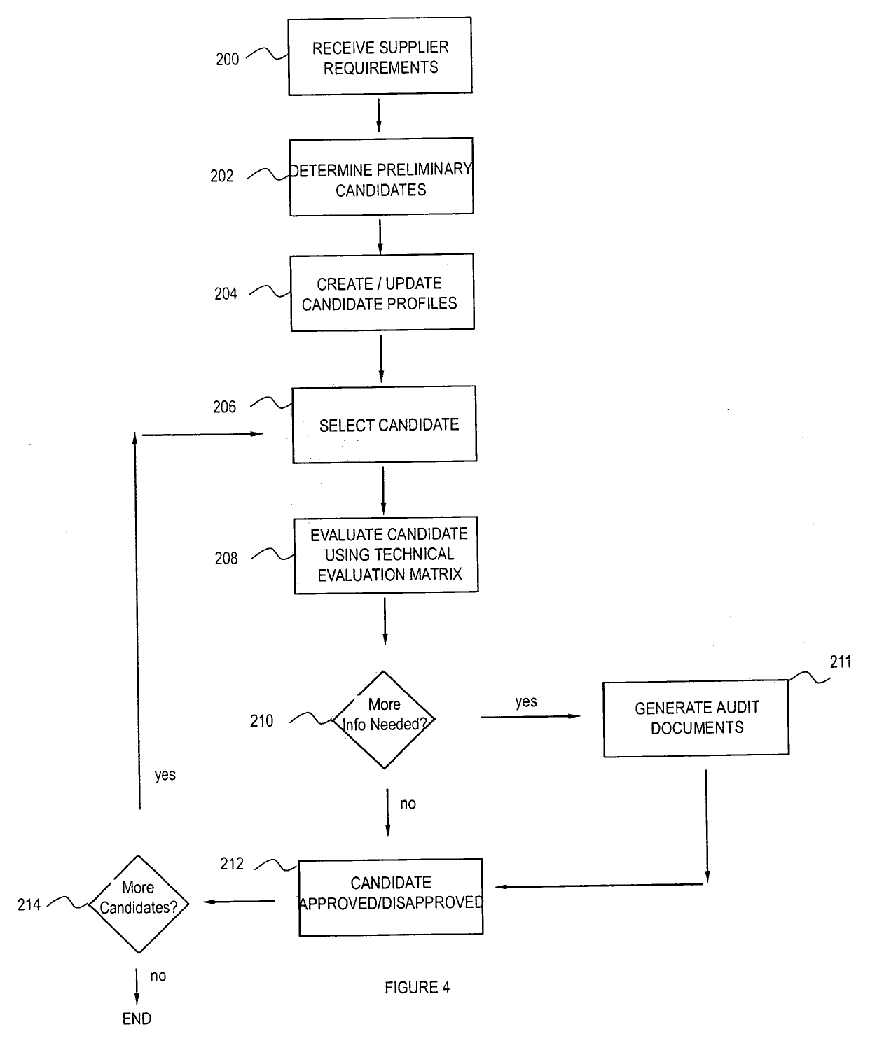

FIG. 4 illustrates steps in an exemplary process for searching for potential suppliers. Some steps illustrated in FIG. 4 may be carried out manually based on data, documents, and other information provided by supplier quality management server 20. However, in some embodiments, some or all of the steps may be partially or fully automated. In some embodiments, the degree of automation depends upon the type of supplier and/or tasks that are involved.

At step 200, supplier requirements are received. Supplier requirements may be formatted in a manner similar to the supplier request that was discussed above in conjunction with determining whether a supplier is on an approved supplier list. In some embodiments, if no approved suppliers are found responsive to a supplier request, quality management server 20 may automatically initiate a supplier search process and use the data included in the supplier request.

At step 202, one or more preliminary supplier candidates are identified. This step may be performed automatically based on analysis of supplier profiles maintained in supplier profile data store 22a. For example, the supplier requirements may be compared to information regarding suppliers known to the system who are not yet approved suppliers for the task at hand. However, some or part of step 202 may involve human involvement. For example, quality management server 20 may generate one or more documents indicating due diligence requirements to be met in identifying new supplier candidates. The due diligence steps may be based on rules triggered by the particular task(s) included in the supplier requirements. One or more forms or other documents, such as auditing documents, may be generated so as to later provide information to the system.

For instance, as noted above, certain manufacturing tasks and/or product lines may be subject to intense regulatory schemes. Part of identifying outside supplier candidates for such tasks/product lines includes narrowing the field of candidates to those with the resources to comply with such schemes. The quality management server 20 may consult one or more rules tables that correlate diligence requirements (and other candidate identification metrics) to tasks. Alternatively or additionally, the diligence and other quality requirements may be included directly as part of the supplier requirements.

Once preliminary candidates have been determined, at step 204 a supplier profile for each candidate is created and/or updated. For instance, some candidates may have pre-existing supplier profiles that did not include information indicating that the candidate could be considered for the task at hand. Other candidates may not have existed in the system at all prior to step 202. At step 204, profiles for all such candidates are updated based on available information, including information determined in step 202. For instance, information may be derived from data filled into forms such as audit worksheets generated to perform a due diligence audit for the respective candidate(s).

At step 206, an outside supplier candidate is selected from the preliminary candidates that have been identified. If only a single preliminary candidate is identified, only that candidate is selected, of course. At step 208, data about the candidate is evaluated. In this example, the evaluation is performed using a technical evaluation matrix. The technical evaluation matrix can include a plurality of requirements that must be met by the candidate in order for the candidate to become an approved supplier for the task at hand.

For instance, the technical evaluation matrix may include descriptions of the enterprise's quality requirements that must be met for a supplier to be approved, such as required certification levels and types, performance benchmarks, and ratings of regulatory compliance. In some embodiments, the technical evaluation matrix comprises minimal scores for various areas that must be met by the supplier. Data in the supplier candidate's profile may be manually or automatically scored, and the profile scores may be compared to the technical evaluation matrix to determine whether or not the supplier is qualified.

For example, supplier quality management server 20 may provide copies of the technical evaluation matrix and related documentation alongside pertinent audit documents regarding the supplier candidate to one or more human decision makers. Based on evaluating the audit data and technical evaluation matrix, the decision maker(s) could indicate results of the evaluation to server 20. Alternatively or additionally, the supplier candidate's profile data may be scored by quality management server 20 using, for example, artificial intelligence routines such as neural networks, expert systems, or other scoring methodologies.

Step 210 represents a check for adequacy of information. This may be performed before, during, or after the actual evaluation of supplier candidate data. For instance, depending upon the task at hand, more information may be required before a supplier candidate can be approved. For instance, as noted above, a profile for a new supplier may only include information available from the initial due diligence investigation. Alternatively, an existing supplier may have information available, but the information may be out of date and/or not to the required degree of granularity.

As an example, an existing supplier may be fully qualified with ample information in the system available regarding the supplier's provision of product packaging for a first product line. However, qualification of that supplier for a second product line may require further detail. Assume, for instance, that the second product line is a cosmetic product and the first product line is a personal care product. Although the candidate may be qualified for the personal care product, the qualification process for packaging a cosmetic product may require more recent and/or more thorough evaluation data than the qualification for the personal care product.

Accordingly, at step 211, based on which further information is needed one or more audit documents may be generated. For example, the evaluation using the technical evaluation matrix may indicate a gap in the candidate's profile. Based on the missing data and the supplier requirements, audit forms and other data to be used in auditing the candidate to fill the missing gaps can be prepared. For instance, as discussed in further detail below, a scripted spreadsheet (or other applications/documents) may generate a set of auditing worksheets based on defined audit requirements. The audit requirements may be revealed during the evaluation of the candidate.

In other situations, step 210 may indicate that a full set of information is available regarding the candidate being evaluated. If so, then at step 212 the candidate is added to the approved supplier list; alternatively, the supplier's profile may be updated to indicate that the supplier is approved for the task at hand.

If the supplier has not met the requirements, then the supplier is not added to the approved supplier list or indicated as approved. In some embodiments, the supplier's profile may be updated to reflect the deficiencies. For example, as noted above, for some suppliers, information may simply not be available, and the system may generate an audit event or process to fill the gaps in supplier information. Similarly, in some embodiments, based on the deficiencies, the system may schedule an event or process to address the supplier's deficiencies. For example, the system may generate one or more documents or other data indicating which areas in which the supplier needs improvement. Additionally, the system may schedule a future audit based on an estimated time of compliance so that the supplier can be re-evaluated.

At step 214, for cases in which there are multiple supplier candidates, the system checks to see if all candidates have been evaluated and, if not, proceeds to select another candidate. Step 214 may indicate an ongoing process. As noted above, some candidates may fail to be approved due to a lack of information and/or due to failure to meet certain requirements. Step 214 may, in some embodiments, comprise a periodic or scheduled checkup on the progress of such candidates. For instance, for candidates for which audit documents are generated, step 214 may schedule a later time at which the candidate will be evaluated against the technical evaluation matrix. In some cases, the evaluation may be triggered when the required information is added to the supplier profile.

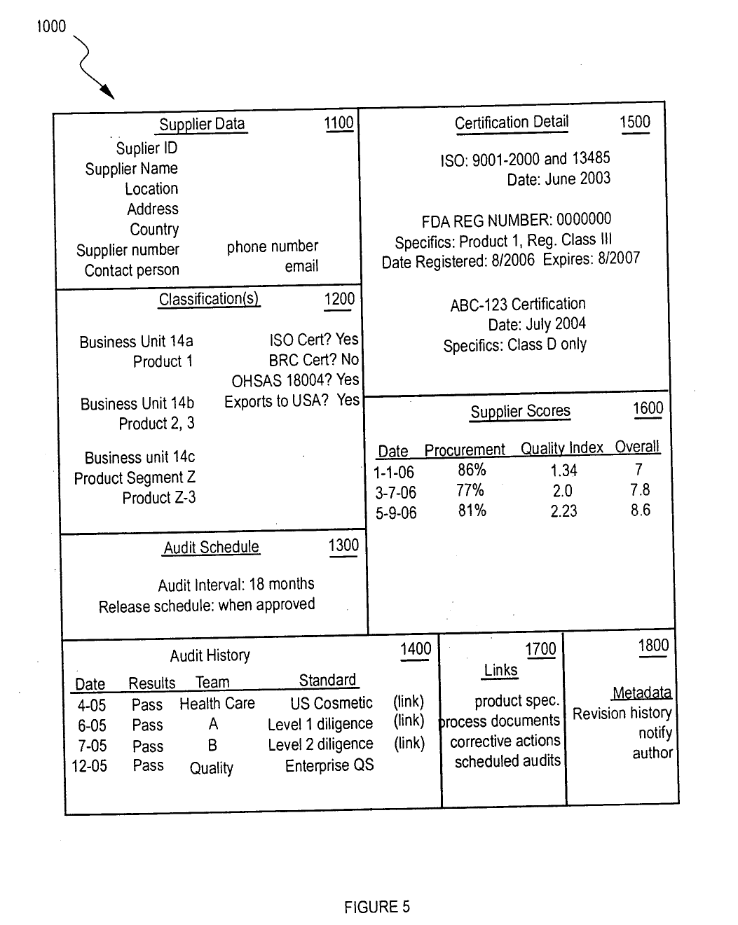

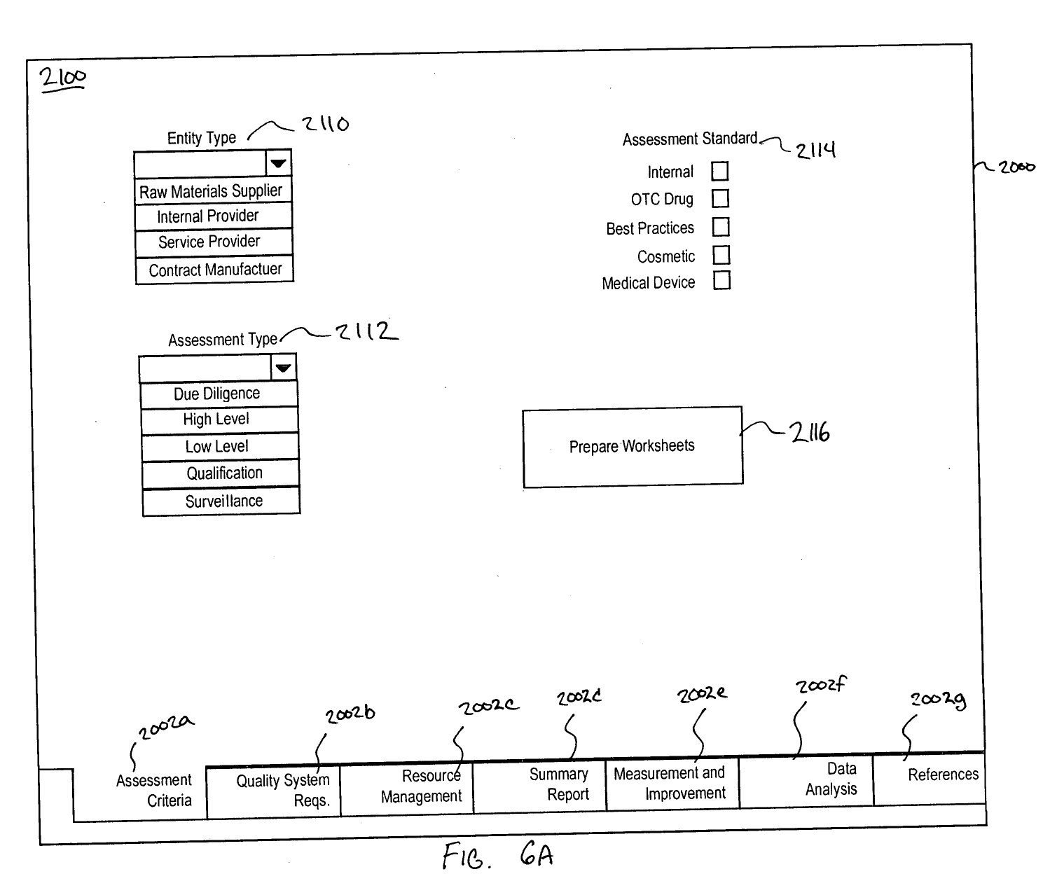

FIG. 5 is an example of a supplier profile 1000 that may be assembled, maintained, and utilized by the supplier quality management system. Profile 1000 may be stored as a record or combination of cross-linked records in one or more databases using any suitable file format or combinations of formats. For instance, the data indicated in FIG. 5 may be divided into physical or electronic documents for viewing by auditing and other quality management personnel. Data included in the supplier profile may also be used as the basis for queries such as the ones discussed above regarding locating approved suppliers, determining whether a supplier is approved, and determining the extent and requirements of required supplier audits. Supplier profile 1000 and/or components thereof may be subject to one or more access restrictions. For instance, only certain users may have permission to alter the profile or view one or more protected components, while other users may view but not change the profile or underlying data.

Supplier profile 1000 includes supplier identification data 1100. In this example, supplier identification data 1100 includes a unique supplier ID. A unique supplier ID may be advantageous in that it may serve as the basis for consolidating information about a particular supplier from multiple sources. For instance, multiple business units may maintain information about the same suppliers using different identification data. Furthermore, even within a single business unit (or the enterprise itself), information about the same supplier may be maintained using different identification data. The supplier identification data 1100 may include other supplier identification numbers used by other systems in the enterprise to facilitate cross-referencing information about the supplier.

For example, the enterprise may maintain information about suppliers in an enterprise resource planning system such as SAP. Rather than maintaining duplicative (or possibly inconsistent) information about a supplier in the supplier quality management system and one or more ERP systems, the information stored in the ERP system(s) such as SAP may be cross-referenced to supplier data 1100 in a supplier's profile. For instance, as shown in FIG. 2, the quality management server(s) 20 are linked to the other enterprise server(s) 21. Information in the other enterprise server(s) 21, such as supplier information maintained in SAP, may be cross-populated to the respective supplier profile, for example, on a nightly basis (or any other irregular or regular time intervals). Other information that may be maintained as part of supplier identification data 1100 includes the supplier's name, address, contact information (such as one or more contact names, email addresses, telephone numbers, etc.).

Profile 1000 further includes one or more sets of classification data 1200 for the supplier. For example, the supplier may be classified based on the business unit(s), product sector(s), and specific products or tasks for which the supplier is being utilized. The degree of granularity may be varied—for example, in some embodiments, the classification may be a taxonomy that includes business unit, product sector, division, product type, and particular product lines. Classification data 1200 can further include data indicating certifications and/or other approvals. For instance, data may indicate whether the supplier is certified for each of a plurality of certification types. When presented in human-readable form, the data may be rendered, for example, as a checklist.

Profile 1000 may further include audit schedule and status information 1300. For instance, the profile may indicate the schedule for auditing the supplier, as well as the supplier's current audit status (such as whether an audit is in progress, the date of the next scheduled audit, or other indicator(s)).

Profile 1000 may also include audit history data 1400. For example, in one embodiment, the audit history includes, for one or more past audits of the supplier: the audit date(s), results, auditor team, and the audit standard. In some embodiments, each item may have a link to one or more source documents which can be accessed by users of the quality management system (and/or the system itself). For example, the audit history may include a link to the appropriate specifications that include the standard(s) used in a past audit. Similarly, the audit results in the audit history data may include one or more links to audit reports, scorecards, and other audit documentation. As will be discussed below, the present subject matter includes tools whereby auditing documents such as audit worksheets can be automatically generated. Links to completed audit worksheets (or the worksheets themselves) may be included in the audit history data 1400.

In some embodiments, profile 1000 includes detailed certification data 1500. For example, although the classification data 1200 includes indicators of certification, the classification data 1200 may include only a minimal level of detail regarding certifications. Certification data 1500, on the other hand, may include, for each certification, the type, date, textual description of the certification type in more detail, date of certification, and the like. For example, for certain products, the outside supplier must be registered with the Food and Drug Administration (FDA). Classification data 1200 may indicate the presence or absence of such registration, while certification data 1500 includes further details such as the FDA registration number, date of registration, and so on.

Depending upon the activities carried out by the enterprise, profile 1000 may include still further information. For instance, some enterprises may perform quality reviews based on internal standards in addition to regulatory, certification, and other outside standards. The results of such internal reviews may be included in supplier scoring data 1600. For example, in one embodiment, the profile includes at least one supplier score for one or more fields as judged by the enterprise in areas such as cost, timeliness, and/or delivery success. Such information may be used to qualify suppliers not only according to external standards, but also to determine which supplier best conforms to the enterprise's internal guidelines for success. For example, one or more of the scores may be obtained from an audit of the supplier and included in auditing documents as will be discussed below.

Profile 1000 may include link data 1700 that cross-references other applicable documents known to the enterprise to be applicable to the supplier. For example, the supplier profile may be treated as a single source for production specifications, corrective action requests, ongoing assessment schedules, and other documentation associated with the supplier. In embodiments in which the supplier profile is implemented as part of a larger management system, the links to other documents may cross-reference data maintained by other components or modules of the management system, such as document tracking.

Profile 1000 may also include profile metadata 1800. For example, profile metadata may include authors of the profile or documents contained therein, changes and history of the profile and its components, and one or more users to be notified when the profile changes. Additional information, such as access history and data used for indexing and searching the profile may also be included in profile metadata 1800.

Next, an example of a quality assessment document that may be generated for use with the quality assessment system will be discussed. For example, as discussed above, more information as to various procedures, management structure, resource management, and other aspects of a supplier's operations may be needed before a supplier can be certified and/or otherwise approved for a particular task. Similarly, when an entirely new supplier is sourced, specific types of information will be required to varying degrees of detail depending upon the task(s) for which the supplier is being sourced. Furthermore, generally speaking, a certification or other assessment is only valid for a limited time, so varying degrees of information gathering will be ongoing even for approved suppliers.

Typically, such information is obtained through auditing the supplier. For instance, one or more teams of personnel will visit the supplier and/or review the supplier's documentation, performance records, and otherwise evaluate the supplier's operations. The audit may evaluate the outside supplier based on internal (i.e. the enterprise's own) standards and/or external standards. For example, the audit team may evaluate the supplier's compliance with applicable regulatory requirements both through direct observation and by reviewing documentation and procedures.

Preparation of such audits may be an expensive task, both in terms of material and personnel resources. For instance, for any particular audit, the audit type and depth must be determined, the requisite standards must be obtained, forms must be assembled, and a team must be assembled and scheduled to perform the audit. Even if pre-generated forms are available, collection and selection of the correct forms may be very time-consuming. Furthermore, if an inaccurate selection is made (such as selection of the wrong form or omission of a form), the audit may be delayed or otherwise reduced in efficiency and/or effectiveness. Tools associated with the quality management system can be used in support of the auditing processes to avoid such problems.

For example, as was noted above, during the process of determining whether a supplier is an approved supplier, the analysis of the supplier's profile may indicate that certain information is lacking. One or more auditing documents may be generated based on determining the gaps in a supplier's profile information and the type of information needed to complete the quality assessment.

For instance, in the following examples, a spreadsheet document includes macros so that a set of audit documents is automatically produced based on audit definition factors such as the type of entity, the scope of the required audit, and the type of the required audit. As discussed below, in some embodiments, the spreadsheet document includes all applicable fields, but only certain fields are made visible based on selection of the audit definition parameters by an end user, such as via drop-down menus in the spreadsheet. The spreadsheet or other document may be formatted for easy migration of the audit data into the quality assessment system.

The number and extent of such areas will depend on the particular audit for which the document is generated. For example, if valid audit data is available regarding an enterprise's management accountability, an automatically-generated audit document will include little or no worksheets or data entry areas regarding management accountability. Similarly, if the assessment type is, for example, a full ISO certification, the audit document may comprise several additional areas with more in-depth coverage. In some instances, multiple audit documents may be produced.

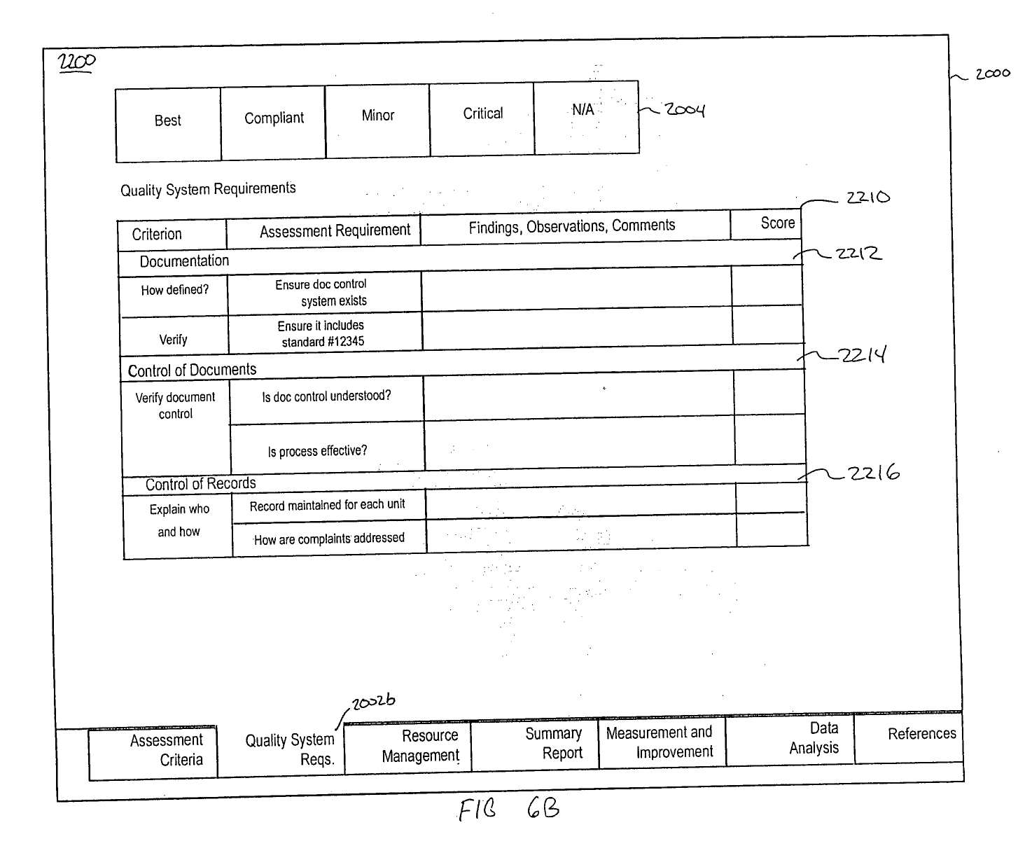

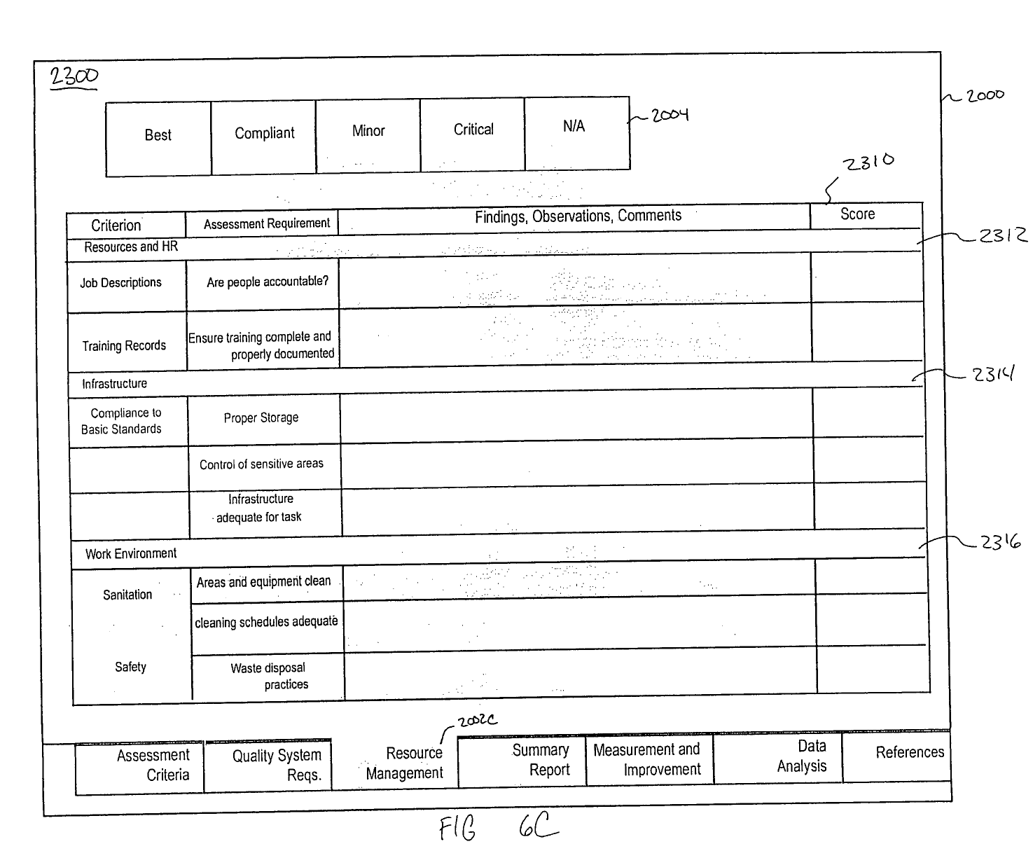

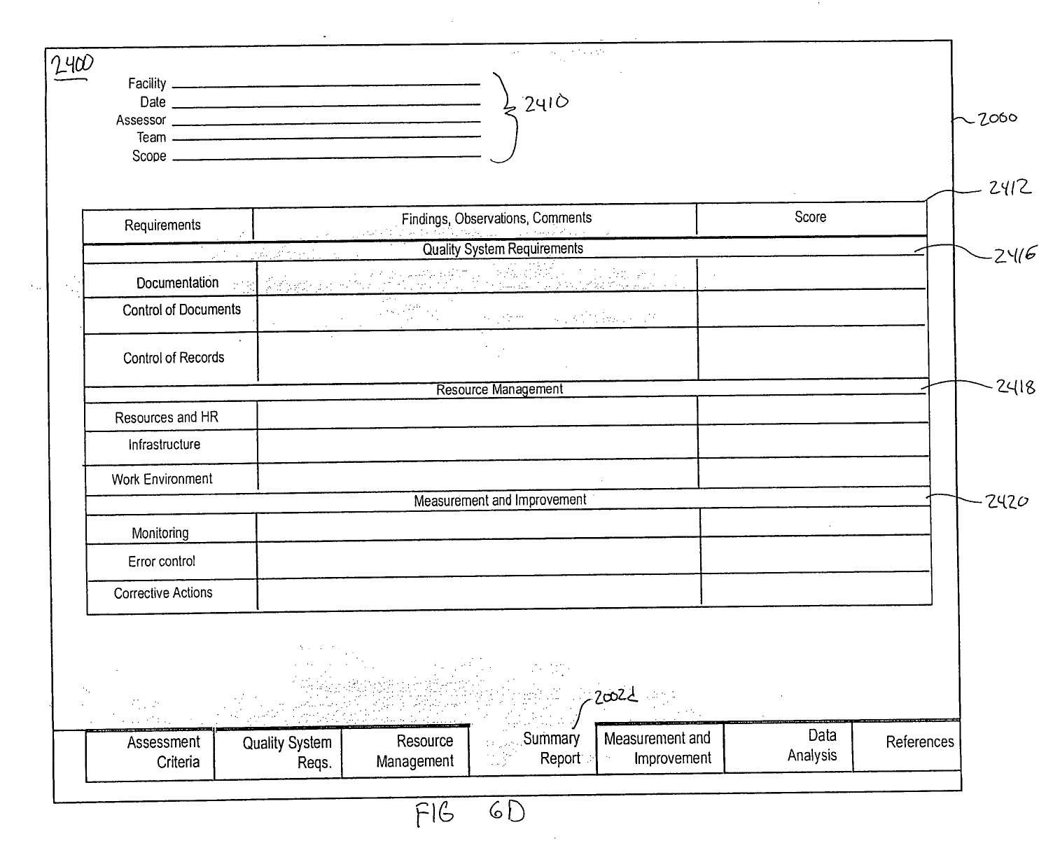

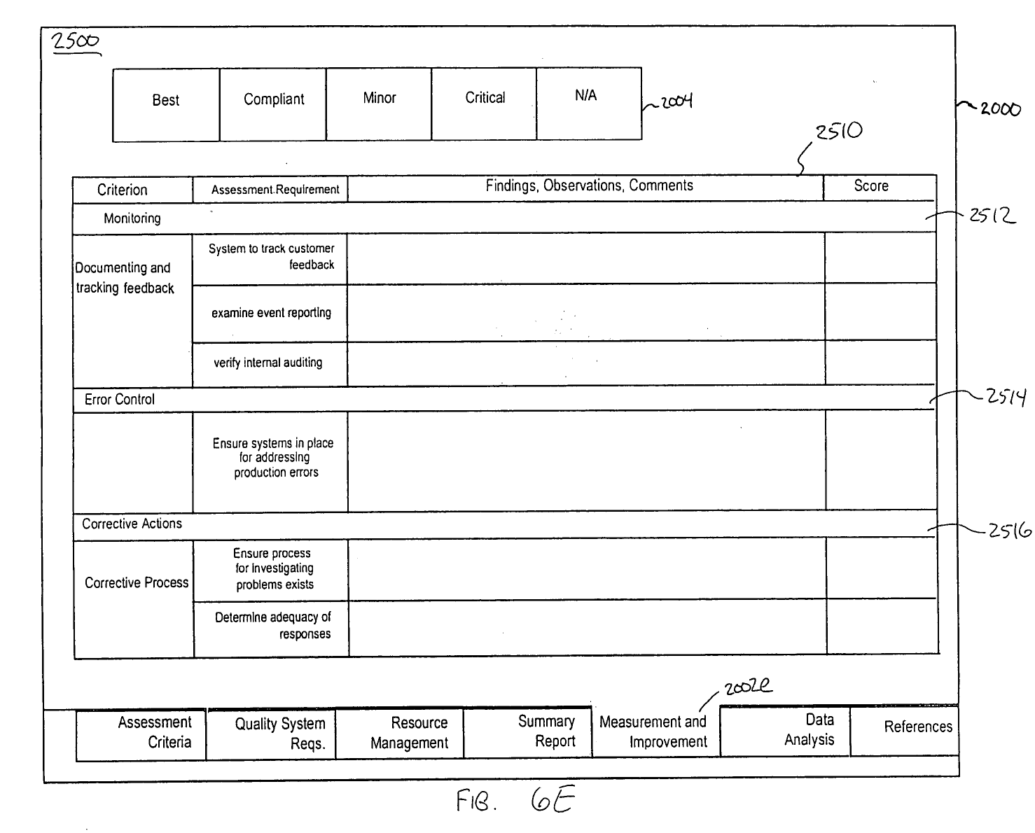

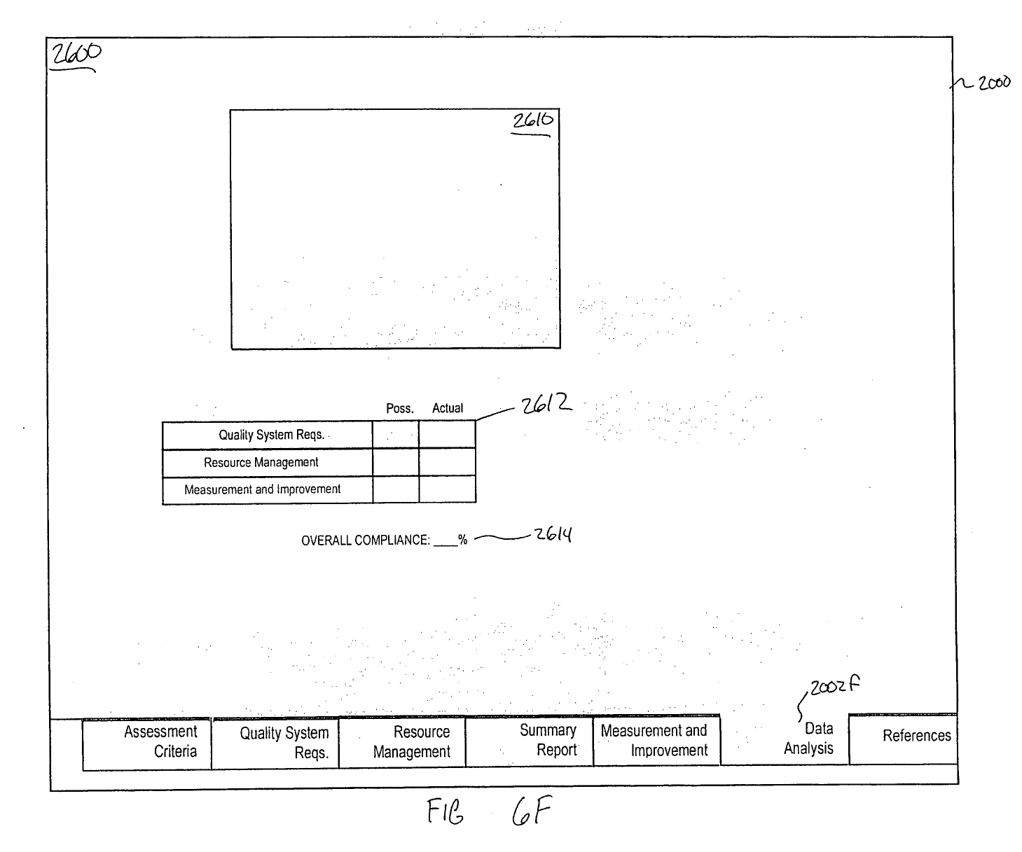

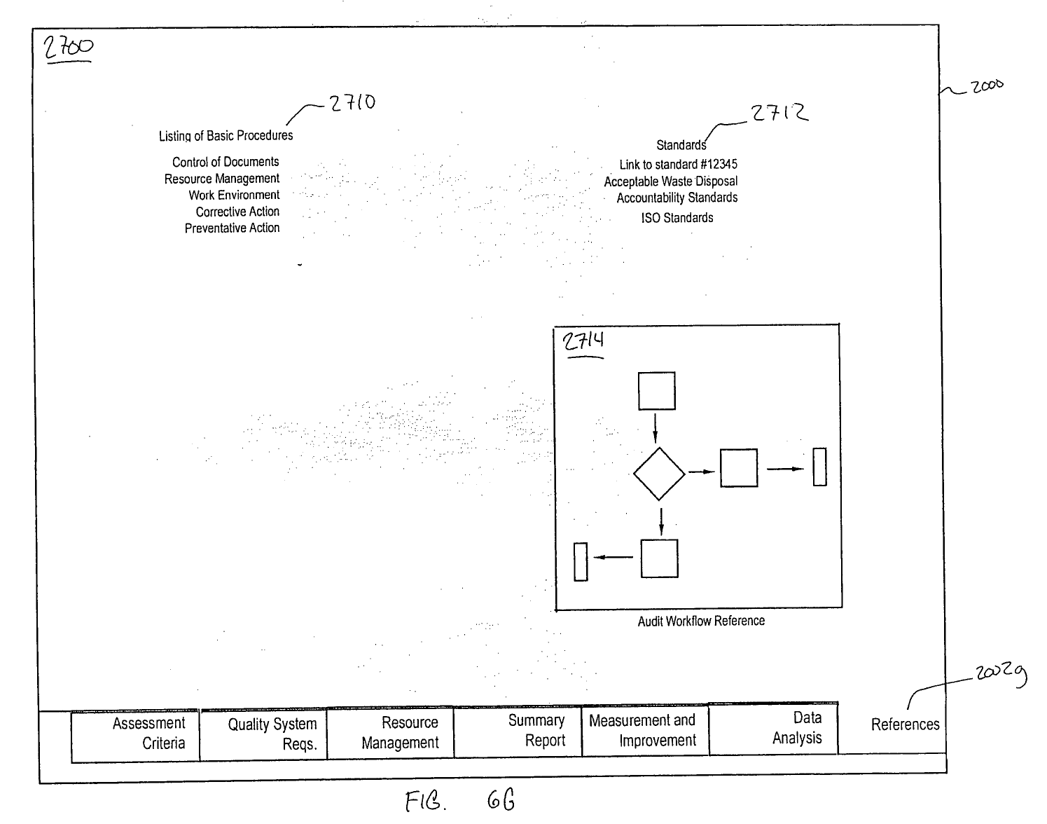

FIGS. 6A through 6G illustrate aspects of an exemplary set of auditing documents. In this example, FIGS. 6A through 6G each illustrate worksheets in a spreadsheet workbook. Custom audit documents are generated using macros supported by the spreadsheet application, which in this example is Microsoft Excel (available from Microsoft Corporation of Redmond, Wash.). However, the particular application and/or data type are unimportant. For instance, any suitable spreadsheet application and file format(s) could be used. Furthermore, other types of documents could be used instead of a spreadsheet. For instance, a set of auditing documents could be generated using an Access database (for use with Microsoft Access, available from Microsoft Corporation of Redmond, Wash.) or other database documents, scripted html documents, xml documents, and any other suitable type or types. Customization may be provided by any type or types programming methodologies, including scripts, macros, or other logic built in to the audit document(s) or provided as components separate from the document(s).

In the exemplary worksheets below, certain types and arrangements of auditing options, assessment worksheets, and other associated documents and functionality are shown. This is for purposes of example only. In practice, auditing spreadsheets (or other suitable structured documents) can have varying forms and content based on the particular implementation and auditing requirements. Therefore, it is intended that particular fields and values shown in the following examples are for purposes of illustration and explanation only.

FIG. 6A illustrates a first worksheet 2100 of spreadsheet document 2000 selected by tab 2002a. Worksheet 2100 comprises several selection areas whereby a user accessing spreadsheet document 2000 can specify the type of audit or assessment the user wishes to conduct. After the various parameters are chosen, the user can select the “prepare worksheets” button 2116. Upon selection of button 2116, macros (or other suitable scripting or programming elements) generate documents for use in conducting an audit/assessment of the type described by the chosen parameters.

In this example, the audit may be specified on the basis of the entity type, assessment type, and the assessment standard.

Entity type selection menu 2110 in this example comprises a plurality of drop-down choices including various types of outside suppliers such as a raw materials supplier, service provider, and contract manufacturer. Furthermore, in this example, the entity type may be an internal provider. For instance, an enterprise may wish to audit/assess its own internal business units for various purposes. Inclusion of the standards for auditing internal suppliers provides for consistent treatment between inside and outside suppliers. For example, a diaper manufacturing business unit may wish to qualify a nonwoven materials manufacturing unit of the same enterprise as a supplier. The particular entity types can vary according to the enterprise's outside suppliers and how the enterprise classifies such suppliers. Other entity types could include, for example, packaging contractors or finished materials suppliers.

Assessment type selection menu 2112 is comprises another plurality of drop-down choices including the various types of assessments or audits that may be performed. In this example, the types include due diligence, high-level, low-level, full qualification, and surveillance. For instance, a completely unknown supplier may require a full qualification, while a known supplier may simply require an “update” achievable using a low-level assessment or ongoing surveillance. However, the assessment type choices will vary according to how the enterprise categorizes assessments. For instance, in practice, an enterprise may define the scope of assessments differently and/or may provide other assessments.

Another possible assessment type which may be advantageous in some circumstances is a “self assessment.” For example, an enterprise may wish for outside suppliers to perform self-evaluations, which may be less in-depth than the enterprise's own evaluations but still helpful in that useful information is obtained. A set of self-assessment worksheets can be prepared and then provided by the enterprise to the outside supplier to ensure that the outside supplier provides information in a format useful to the enterprise. In some embodiments, document 2000 may include support for a change in the file format used in order to prevent proprietary information from reaching the outside supplier. For instance, an additional command button could be included whereby a file format such as a PDF or tiff is produced so that the outside supplier receives worksheets but not the underlying data, macros and/or other data or metadata associated with document 2000. Of course, other file formats could be suitable, as well.

Exemplary worksheet 2100 further includes assessment standard selection area 2114, which in this example comprises a plurality of checkboxes. Various assessment standards may be defined, and this example shows standards including internal, OTC (over-the-counter) drug, best practices, and cosmetic and medical device standards. As was noted above, a very in-depth assessment may be required when qualifying or otherwise assessing a manufacturer of medical devices. In this example, selection of the “medical device” checkbox triggers generation of the more in-depth audit requirements (although the scope of the audit will, of course depend on other selected parameters).

Worksheet 2100 includes entity type, assessment type, and assessment standard parameters. However, additional or alternative parameters may be provided for selection depending on the activities and auditing requirements of an enterprise. For example, additional parameters may include other standards or certifications. Ultimately, the parameters will depend on the auditing requirements of the enterprise, how the enterprise classifies audits, and how components (such as criteria, assessment requirements, and the like) are characterized. For instance, a low-level assessment for a first enterprise may comprise a level of detail that corresponds to a second enterprise's definition of “surveillance.” Furthermore, parameters may be specified in any suitable manner, and the particular selection mechanisms shown herein (i.e. drop-down menus and checklists) are for example only.

In this example, based on the various selection parameters, a macro, script, or other suitable processing component(s) match the parameters to a stored collection of assessment components and assemble one or more additional worksheets so that the worksheet(s) comprise a full set of documents for conducting an audit in accordance with the selected parameter(s). For example, document 2000 may comprise a full set of questions, requirements, or other standards that are used in the assessment process. In this example, based on the parameters, some of the questions/requirements/standards are hidden while others are made visible. For instance, for a full qualification audit of a contract manufacturer, more questions/prompts may be visible than for ongoing surveillance. Similarly, if a particular assessment standard is not selected, questions that relate only to that standard will remain hidden.

The actual process of assembling the auditing documents may vary. In this example, macros are included as part of document 2000. However, the macros, scripts, or other processing component(s) that assemble the worksheet(s) may be separate from the worksheet(s) in other embodiments. For instance, in other embodiments, a database of auditing document components may be queried and questions/prompts/standards that are applicable may be retrieved and assembled into one or more worksheets. In still further embodiments, a separate application, process, executable file, or system component may assemble a set of one or more auditing worksheets in response to selection criteria.

In some embodiments, the selections may be configured so that inconsistent or unintelligible combinations of parameters may not be selected. For example, if a particular enterprise does not define a “surveillance” audit of a service provider for OTC drugs, then document 2000 (or the other audit document assembly component(s)) may be configured so that those selections cannot be made simultaneously.

Additional aspects of spreadsheet document 2000 as prepared for an exemplary audit will now be discussed. In this example, assume parameters were selected such that document 2000 prepared audit worksheets for assessing quality system requirements (tab 2002b), resource management requirements (tab 2002c), and measurement and improvement requirements (tab 2002e).

FIG. 6B illustrates audit worksheet 2200, which in this example comprises a worksheet for assessing quality system requirements. Worksheet 2200 includes scoring parameters 2004 and data entry area 2210. In this example, data entry area 2210 includes various criteria, one or more assessment requirements for each criterion, and two data entry areas. The finding, observations, and comments area provides a space for the audit personnel to document their findings with respect to each criterion and related assessment requirement(s). The score area provides space for the audit personnel to indicate a measurement of compliance.

For instance, the score may comprise a letter, number, color, or other measurement indicator. In some embodiments, scoring parameters 2004 may be linked to the score area for each assessment requirement. For instance, scoring parameters 2004 may comprise a color scale from blue (best) to red (critical). Each assessment requirement may be scored in accordance with the color scale. For example, the spreadsheet may be configured so that a user can select the score area for one or more assessment requirements and click on the applicable score value in the scoring parameter set 2004. Colors or other indicia may link to corresponding numerical values or other scoring indicators. Although the auditing worksheets display the same parameters 2004, the underlying score may differ depending on the particular audit worksheet. For instance, in worksheet 2300, a “good” rating may be worth 5 points, while a “good” rating may be worth 50 points in worksheet 2300. Similarly, the ratings may be weighted differently within worksheets for different criteria/assessment requirements.

In this example, the audit includes a “Quality Systems Requirements” portion wherein the supplier's compliance with standards for documentation (2212), control of documents (2214), and control of records (2216) must be assessed. For instance, under “documentation,” the audit team is directed to determine how document control is defined and whether a control system exists and to verify that it includes standard #12345. The auditing team can document its results with regard to each of the criteria in the “Findings, Observations, Comments” area by typing data into the requisite cell and by providing the team's score for each criterion in the appropriate cell under the “score” heading. The particular definitions of audit criteria and assessment requirements will, of course, depend on the actual audits that are to be implemented.

As will be discussed below, the findings, observations, and comments area associated with each assessment requirement may be linked to another portion of document 2000. Specifically, as will be discussed in conjunction with FIG. 6D, in some embodiments, document 2000 includes a summary report including findings for the different assessment areas. In some embodiments, portions of the summary report may be linked to areas for user input in a manner that the comments, observations, and findings for each audit worksheet are echoed in the summary report under the requisite heading. Additionally, in some embodiments, the score for each requirement is linked to one or more scoring summary indicators. As will be discussed in conjunction with FIG. 6F, in some embodiments, the score for each requirement may be aggregated into a total score for the assessment. Additionally, the score for each criterion (in this example, the total “documentation” score, the total “control of documents” score, and the total “control of records” score may be aggregated and included in the summary document.

FIG. 6C illustrates an audit worksheet 2300 (selected by tab 2002c) for use in assessing resource management requirements. Worksheet 2300 includes scoring parameters 2004 and data entry area 2310. In this example, a resource management audit includes assessment of the supplier's resources and HR operations (2312), infrastructure (2314), and work environment (2316). As noted above, these particular auditing requirements are selected based on the parameters that were chosen. For instance, an audit of a different entity type, different assessment type, or other assessment standard(s) may result in additional or fewer criteria and/or assessment requirements than are illustrated. For example, a medical device assessment may result in additional infrastructure requirements, such as more stringent security and storage standards.

FIG. 6D illustrates a summary report worksheet 2400 selected by tab 2002d. Summary report worksheet 2400 may be assembled based on data entered into the generated audit worksheets. Summary report worksheet 2400 includes audit data 2410 including identification of the facility or entity audited, the data, the lead assessor, audit team, and scope of the audit. Additional data entry fields may be included depending on the audit parameters. Summary worksheet 2400 further includes summary report area 2412. Report area 2412 in this embodiment includes sub-areas corresponding to the different factors assessed in the other audit worksheets. For instance, report area 2416 includes findings, observations, and comments from the assessment of Quality System Requirements shown in FIG. 6B. In this example, those requirements were organized by documentation (2212), control of documents (2214), and control of records (2216). Textual data input for criteria/assessment requirements under each heading may be reproduced under the appropriate heading in the summary report worksheet. This can result in appreciable time savings for the audit team since results from each audit worksheet do not need to be re-typed or otherwise entered twice. Although the examples herein only include three audit worksheets, an actual audit could include many more worksheets of much greater detail than are presently illustrated. Accordingly, the audit team may save substantial amounts of time in preparing a summary report. Report area 2418 summarizes findings from the resource management worksheet shown in FIG. 6C in a similar manner, while area 2420 summarizes findings from the measurement and improvement worksheet that will be discussed in conjunction with FIG. 6E below.

Similarly, as was noted above, the audit worksheets may include scoring areas for each assessment requirement. The scores for each requirement may be aggregated for each applicable sub-heading and included in the score area in the summary report. For example, the resource management audit worksheet included requirements under resources and HR (heading 2312), infrastructure (heading 2314) and work environment (heading 2316). Scores under each heading can be aggregated and presented in summary report area 2418. For example, the “resources and HR” score under heading 2418 can include the result of aggregating the scores for the “Job Descriptions” and “Training Records” criteria shown in FIG. 6C. Similarly, the score for “Infrastructure” under heading 2418 may correspond to aggregating the scores for “proper storage,” “Control of sensitive areas,” and “Infrastructure adequate for task” from FIG. 6C. Although term “aggregating” is used, any mathematical operation or operations may be suitable, and the actual calculation(s) performed will depend on the enterprise's defined scoring scheme(s) for the audit. For instance, in some audits, resource management considerations may not be weighted in the same manner as those related to product or service realization.

As mentioned above, FIG. 6E illustrates an exemplary audit worksheet 2500 (selected by tab 2002e) for assessing compliance with measurement and improvement standards. Data entry area 2510 includes headings for compliance regarding monitoring (heading 2512), error control (heading 2514) and corrective action (heading 2516). As noted above, the summary report for this audit includes sub-headings corresponding to headings 2512, 2514, and 2516. Reproduction of findings, observations, and comments and aggregating scores for the various criteria and assessment requirements shown in FIG. 6E occurs in a manner similar to the audit result data from the worksheets of FIGS. 6B and 6C.

In this example, audit spreadsheet document 2000 further includes additional worksheets 2600 and 2700, selected by tabs 2002f and 2002g, respectively. FIG. 6F shows worksheet 2600 which, in this example, provides indicators of overall scores for the audit. In this example, the worksheet includes graphic display area 2610, numerical score area 2612, and overall score 2614. In this example, score area 2612 shows a total score for each of the Quality System, Resource Management, and Measurement and Improvement requirements. Specifically, score area 2612 includes a total possible score and an actual score. For instance, each criterion and/or assessment requirement may be associated with a set number of points. The score for each criterion/assessment requirement may be added into a total for each area of assessment which may be added into a total for the audit. The total actual score may be compared to the total possible score, for example, to obtain a percentage figure representing the overall score for the audit. The percentage figure (and/or other indicator of overall score) may be included in the supplier (or other entity's) record, such as in score area 1600 of record 1000 shown in FIG. 5. FIG. 6F also includes graphical display area 2610, which may comprise one or more graphs, charts, or other representation of the audit results. For example, the score may be broken down by audit worksheet, criterion, or any suitable degree of granularity. Furthermore, although not shown in FIG. 6F, multiple different scores may be displayed. For example, if the audit includes multiple schemes or types of scoring, then the final score under each applicable scheme can be displayed. In such embodiments, the audit worksheets may include multiple scoring areas so that score(s) for each type can be provided.

FIG. 6G shows reference worksheet 2700. In some embodiments, audit document 2000 may include one or more references that may be consulted by the auditing team in the course of evaluating an outside supplier (or other entity). In this example, reference worksheet 2700 includes a listing 2710 of basic procedures, a listing 2712 of standards, and a graphic 2714 showing the audit workflow (details of the workflow are not illustrated). For instance, particular audit types may include specific rules, procedures, and other protocols to be followed by the audit team. Reference worksheet 2700 may provide information about such protocols and/or links to other documents or files. For example, Quality System Requirements audit worksheet 2400 included various criteria under Control of Documents heading 2214. Reference worksheet 2700 includes a “Control of Documents” item under listing of basic procedures 2710. For instance, the item may link to standards, specifications, or other documentation that sets forth document control requirements in greater detail. Similarly, items standards list 2712 may link to various standards associated with the particular audit criteria and assessment requirements.

The particular audit documents that were illustrated in FIGS. 6A-6G are intended for purposes of example only. In practice, the documents may comprise additional worksheets or other sub-documents related to the audit process and/or other components for use in assembling an audit report. For example, in some embodiments, additional tabs may be included so that the document can be navigated and presented, such as a cover page, executive summary indicating the facility (or entity) basic information, and a table of contents that links to various sections of the document. As was noted above, the use of a spreadsheet is convenient, but the present subject matter is not intended to be limited to implementations using spreadsheets only.

Furthermore, it is to be understood that additional worksheets and criteria may be included based on the audit that the document is to support. For instance, in some embodiments, the document includes worksheets for auditing quality system requirements, management accountability, resource management, product and service realization, measurement, analysis, and improvement. Product and service realization, for instance, may include some of the more extensive and in-depth auditing criteria such as planning, customer relations, design and development, sourcing and supply, product provision, and control of product monitoring devices.

Although several examples herein related to enterprises and assessments of suppliers in the manufacturing context, the present technology is also applicable to enterprises and/or assessment of suppliers in the context of other industries and economic sectors.

It is appreciated by persons skilled in the art that what has been particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

1. A method of supplier management, the method comprising:
a. receiving an supplier identification query, wherein the query includes data defining one or more supplier capability requirements;
b. accessing a plurality of supplier profiles, wherein each profile is associated with a supplier;
c. identifying, from the profiles, one or more capable suppliers, wherein a capable supplier is a supplier that meet the one or more supplier capability requirements;
d. determining one or more supplier quality requirements;
e. accessing quality assessment data associated with each capable supplier;
f. determining which capable suppliers are approved suppliers based on the quality assessment data and the one or more supplier quality requirements; and
g. generating an approved supplier list, wherein the approved supplier list includes only those capable suppliers that are also approved suppliers.

2. The method as set forth in claim 1, wherein the supplier capability requirements define at least one task to be performed by a supplier, and wherein at least one supplier quality requirement is determined based on the at least one task.

3. The method as set forth in claim 1, wherein at least one supplier quality requirement is determined based on a quality requirement included in the supplier identification query.

4. The method as set forth in claim 1, wherein determining which capable suppliers are approved suppliers includes, for each supplier:
a. accessing at least one score included in the quality assessment data for the supplier, and
b. comparing each score to a corresponding threshold score;
c. wherein each threshold score is determined based on the supplier quality requirements.

5. The method as set forth in claim 1, further comprising accessing data associated with a supplier in an enterprise resource planning system and storing at least some of the accessed data in a supplier profile.

6. A quality management system, comprising:
a. at least one database including:
i. a plurality of supplier profile records, and
ii. a plurality of supplier quality assessment records;
b. at least one computing device, the computing device configured to access stored instructions that configure the computing device to perform actions including:
i. receive a supplier query, the query including data defining one or more supplier capability requirements and one or more supplier quality requirements;
ii. access the at least one database and determine which suppliers, if any, meet the supplier capability requirements;
iii. access the at least one database and determine which suppliers, if any, meet the supplier quality requirements; and
iv. generate an approved supplier list, the approved supplier list including those suppliers, if any, that meet both the supplier capability requirements and the supplier quality requirements.

7. The system as set forth in claim 6,
a. further comprising at least one additional database associated with an enterprise resource planning system;
b. wherein at least some of the data in the supplier profile records comprises data for one or more suppliers cross-populated from data in the at least one additional database.

8. A method of supplier management, the method comprising:
a. receiving an supplier identification query, wherein the query includes data defining one or more supplier capability requirements;
b. accessing a plurality of supplier profiles;
c. determining one or more supplier quality requirements;
d. based on the supplier profiles and quality requirements, determining which suppliers require further quality assessment data to meet the one or more supplier quality requirements; and
e. storing data defining the needed further quality assessment data.

9. The method as set forth in claim 8, further comprising:
a. based on the needed further quality assessment data, determining one or more supplier audit requirements; and
b. based on data including the one or more supplier audit requirements, scheduling a supplier audit.

10. The method as set forth in claim 8, further comprising:
a. based on the needed further quality assessment data, generating at least one audit document for use in the supplier audit.

11. A method of supplier quality management, the method comprising
a. receiving an supplier identification query, wherein the query includes data defining one or more supplier capability requirements;
b. accessing a plurality of supplier profiles, wherein each profile is associated with a supplier;
c. identifying, from the profiles, one or more capable suppliers, wherein a capable supplier is a supplier that meet the one or more supplier capability requirements;
d. determining one or more supplier quality requirements;
e. accessing quality assessment data for at least one capable supplier;
f. wherein accessing includes determining, for at least one capable supplier, one or more unmet quality requirements based on the quality assessment data.

12. The method as set forth in claim 11, further comprising generating at least one further action recommendation based on the data defining the at least one unmet requirement.

13. A method of assessing supplier quality, the method comprising:
a. receiving data including one or more parameters defining a supplier quality assessment; and
b. generating at least one assessment form, the form customized to the defined supplier quality assessment.

14. The method as set forth in claim 13, wherein receiving data defining one or more supplier quality assessment parameters includes receiving data defining a supplier type, data defining an assessment type, and data defining an assessment standard.

15. The method as set forth in claim 14,
a. further comprising generating at least one drop-down selection menu;
b. wherein at least one of the data defining the supplier type, the data defining the assessment type, and the data defining the assessment scope is received via user selection from a drop down menu.

16. The method as set forth in claim 13, wherein generating at least one assessment form includes selecting at least some predefined assessment requirements from an assessment requirement set based on the one or more parameters defining the assessment and preparing at least one worksheet including the selected assessment requirements.

17. The method as set forth in claim 16, wherein the steps or receiving and generating are performed by at least one scripting element included in a spreadsheet.

18. The method as set forth in claim 17,
wherein the spreadsheet includes the entire set of assessment requirements; and
preparing at least one worksheet includes making the selected assessment requirements visible and the non-selected questions non-visible.

19. The method as set forth in claim 17, further comprising preparing at least one document other than the spreadsheet and including the at least one worksheet in the prepared document.
